(19) United States
(12) Patent Application Publication
(10) Pub. No.: US 2010/0258113 A1
(43) Pub. Date: Oct. 14, 2010

(54) LIGHT WING DEVICE

(76) Inventor: LAWRENCE A. HYATT, Boise, ID (US)

Correspondence Address: DYKAS, SHAVER & NIPPER, LLP, P.O. BOX 877, BOISE, ID, 83701-0877, US

(21) Appl. No.: 12/421,967

(22) Filed: Apr. 10, 2009

(51) Int. Cl. F24J 2/46; E06B 9/24

(52) U.S. Cl. 126/704; 160/368.1

(57) ABSTRACT

A light wing device for mounting on a window in order to provide light reflection has been disclosed. The light wing device generally has a light wing, a mounting mechanism, and the light wing is configured to rotate away from the application of force to the light wing. This rotating light wing prevents premature breakage of the light wing from force encountering the light wing.

### FIELD OF THE INVENTION

The invention generally relates to an apparatus for reflecting light away from a building as well as reflecting light into a building, and more particularly to an apparatus that reflects light and rotates away from a force applied to the apparatus to prevent the apparatus from breaking.

### BACKGROUND OF THE INVENTION

Windows are a very important aspect of buildings in today's society. Windows are generally used to provide lighting, heat, and ventilation to buildings of a wide variety of types and sizes. In the winter, particularly in buildings in more northern locations in the United States, windows are often used to increase lighting as well as heat in a building in order to reduce the cost of lighting and heating the building. In the summer, windows can be used to light the building or to cool the building by allowing the radiant heat to disperse into the outside air or the windows can be opened to allow cooler night air into the building. The difficulty with efficiently using windows as a part of a heating and/or lighting system is in controlling the amount of light or heat that enters or exits a building. In an attempt to solve this problem, various blinds and shades have been developed that are used in buildings throughout society. For example, in the winter the sun is typically at a lower angle than it is in the summer; consequently, sunlight that reaches the building is at a lower energy level. Furthermore, in the summer when the sun is at a higher angle, light directed in the building generally is increased as the sunlight comes from a higher or more direct orientation to the building than winter sunlight. Additionally, sunlight is generally shining on a building for a longer period of time in the summer than in the winter as the daylight hours are longer in the summer. Consequently, in the winter it can be more difficult to heat the building with sunlight; whereas, in summer it can be more difficult to cool the building due to the increased sunlight while at the same time being more difficult to light the building with sunlight as the sunlight increases the temperature of the building. In order to increase the amount of sunlight into buildings in winter while still allowing for more natural light to penetrate the building, a variety of light shelves have been developed that reflect light into the building.

Light shelves have been developed that reflect light both into and out of a window of a building in order to provide both light and shade to the building, depending upon the circumstances. The problem associated with these light shelves is that in high winds or in reaction to a force impacting on the light shelf, consequently the light shelf has to be built to resist these forces or it will have a tendency to break. This leads to a light shelf that is thicker and/or heavier in order to resist breaking. These forces comprise a wide variety, including, but not limited to: wind, falling objects, birds landing or falling on the shelves or even attempting to nest on the light shelf. Consequently, a light wing that can react to force is necessary in today's market place.

### SUMMARY OF THE INVENTION

Accordingly, a light wing device having a light wing that is reactive to exterior force has been invented. The light wing device of the following invention for reflecting light both into and away from a window of a building has a light wing that is able to rotate on a pivot axis toward and away from a force impacting the light wing. The light wing is generally mounted on a building using a mounting mechanism that allows the light wing to rotate. In general, the light wing device is mounted in a first position in which the light wing reflects light into or away from the building or a combination of into and/or away from the building. When a force impacts the light wing, the light wing rotates away from the force towards a second position or in an opposite way towards a third position. This prevents the light wing from breaking in reaction to the force. The disclosure of the invention is intended to include all light wing devices that have light wings that are reactive to exterior forces.

In one embodiment, the light wing can serve as both a light reflection device reflecting light into the building as well as providing shade to the building or to the window. In another embodiment, the light wing device can be positioned at the top of the window where it provides shade to the window without reflecting light into the window. Furthermore, in another embodiment, the light wing can have a biasing mechanism that biases the light wing back towards the first position after it is rotated towards the second or third positions. The biasing mechanism can have a first stop and/or a second stop point that prevents the light wing from rotating too far away from the first position.

Additionally, in one embodiment, the light wing can have an adjustment mechanism for varying the relative first position of the light wing in relation to a building. The adjustment mechanism can come in a variety of forms including a manually adjusted mechanism or a motorized adjustment mechanism. The adjustment mechanism can also have one or more automatic sensors to automatically adjust the light wing device in response to environmental factors, or they can be manually adjusted by a person.

The light wing device of the present invention can be mounted horizontally in relation to a window or it can be mounted vertically, relative to the window, depending upon the needs of the building regarding heating and cooling and light reflection. Additionally, a plurality of light wing devices can be mounted in association with a window. The plurality of the light wing devices can be mounted in either or both of a vertical or horizontal direction. Additionally, solar energy converters or solar energy panels can be mounted in association with the light wing device. Specifically, the solar energy converter can be mounted on the light wing in order to harness solar energy that hits the light wing.

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the invention of the application, which is measured by the claims, nor is it intended to be limiting as to the scope of the invention in any way. The terminology used throughout this application is intended to be relative to the disclosure and not to limit the invention beyond the disclosure herein. For example, while the term “light wing device” is used throughout the application, a wide range of terminology can be used to describe the light wing device or any of the components disclosed herein.

Still other features and advantages of the claimed invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

### BRIEF DESCRIPTION OF THE DRAWINGS

FIG. 1 represents a perspective view of the light wing device.

FIG. 2 represents the light wing device functioning to provide light reflection into the building as well as away from the building.

FIG. 3 represents a view of the light wing device functioning as a shade to the window of the building.

FIG. 4 represents a sheet embodiment of the invention viewed from beneath the invention.

FIG. 5 represents a view of one embodiment of the biasing mechanism attached to the mounting mechanism and the light wing.

FIG. 6 represents a second embodiment of the biasing mechanism attached to the mounting mechanism and the light wing.

FIG. 7 represents an example of the range of motion the light wing can travel when attached to the mounting mechanism.

FIG. 8 represents an illustration of light being reflected into the window as well as away from the window of the building.

FIG. 9 represents an embodiment of the light wing.

FIG. 10 represents the light wing device attached to a window to provide light reflection.

FIG. 11 represents the mounting mechanism as well as a mechanism for moving the light wing first position.

FIG. 12 represents the mechanism for changing location of the first position of the light wing as well as the biasing mechanism for biasing the light wing to return to the first position.

FIG. 13 represents the light wing device mounted vertically on a window.

FIG. 14 represents a plurality of light wing devices mounted horizontally on a window.

FIG. 15 represents the light wing device with a solar energy converter mounted on the light wing.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

Light shelves are widely known throughout society to provide light reflection and shade to a building or to a window of a building. However, these light shelves are not made to withstand the application of force to the light shelf. Consequently, in high winds or when materials or objects encounter the light shelves, the light shelves have a tendency to break.

Accordingly, a light wing device has been invented that is responsive to exterior applications of force to the light wing of the light wing device. Generally, when a force encounters the light wing, the light wing rotates away from the force in order to prevent the light wing from breaking. This will prevent premature breaking of the light wing and prevent potentially costly replacements of the light wings.

In the following description and in the figures, like elements are identified with like reference numerals. The use of “e.g.,” “etc,” and “or” indicates non-exclusive alternatives without limitation unless otherwise noted. The use of “including” means “including, but not limited to,” unless otherwise noted.

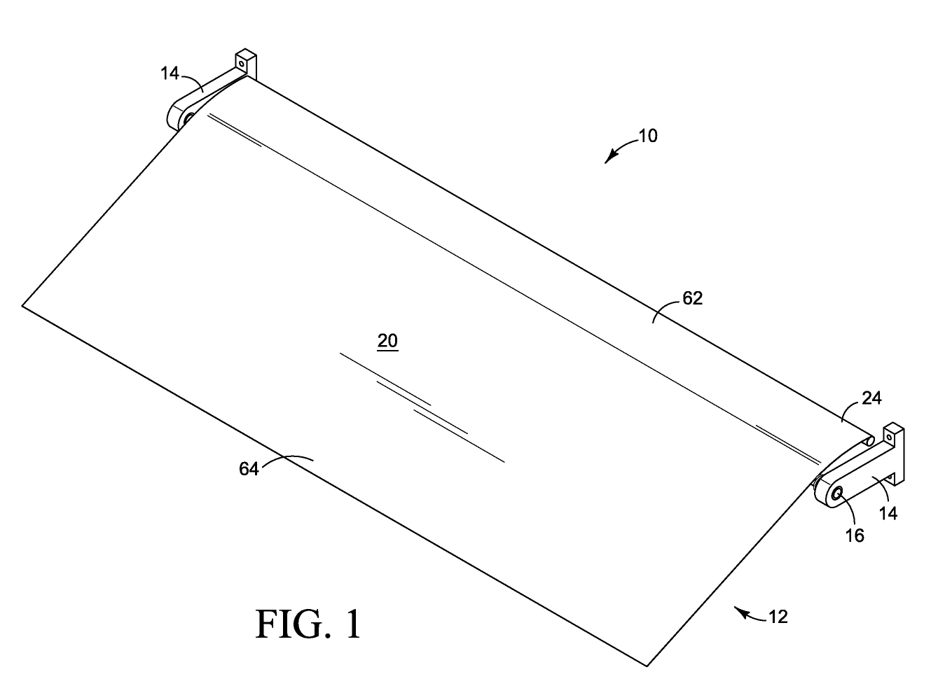

FIG. 1 illustrates an embodiment of the light wing device 10. In this embodiment, when the light wing 12 is attached to a building, the light wing 12 provides shade by providing light reflection away from the building while providing light to the ceiling of a room of the building by reflecting light onto the ceiling of the building. In the embodiment of FIG. 1, the light wing device 10 has a light wing 12 that has a top 20 and a bottom 22 (not shown in FIG. 1). The light wing has an axis of rotation 16 that extends from one end of the light wing 12 to the other end of the light wing 12. This axis of rotation 16 generally establishes two sections of the light wing for purposes of this description, a first section 64 and a second section 62. As illustrated, the light wing is mounted onto a building or other structure by the mounting mechanism 14.

The light wing 12 in the illustrated embodiment is in a general first position in which the first section 64 and the second section 62 of the light wing are generally configured to remain in the first position 28 until a force is applied to the light wing. The first position is a general reference to the position of the light wing 12 when there is no force applied to the light wing 12. The first position can be changed to suit the building or window frame to which the light wing is attached, to enable the light wing to be at a variety of angles when in the first position. The light wing is attached to the mounting mechanism 14 such that the light wing can be positioned at a variety of angles when in the first position. When a force contacts the bottom or top of the light wing 12, the wing rotates away from the force to prevent the force from breaking the light wing. The light wing in some embodiments is generally configured such that the wing requires a sufficient amount of force in order to rotate such that the wings do not chatter in a gentle breeze or rain but instead react to force generally sufficient to break the light wing. This can be accomplished, amongst a wide variety of mechanism, by weighting the two sides of the light wing such that it maintains the first position when a small relative amount of force is applied to the light wing or by adjusting the biasing mechanism such that the light wing will not rotate without the impact of a sufficient amount of force on the light wing 12. As illustrated, the counter weight system 24 operates such that the axis of rotation 16 is generally in the center of the weight distribution of the wing. In the embodiment of FIG. 1, approximately half of the weight of the light wing is distributed on the first side of the light wing while approximately half of the weight of the light wing is distributed on the second half of the light wing. The light wing is counterbalanced such that, after the light wing has rotated away from the force and the force subsides, the weight of the counterbalanced light wing will bias the light wing back toward the first position. In this embodiment, the weight of the first side of the light wing and the weight of the second side of the light wing can be varied such that the pivot axis can be positioned in varying locations on the light wing, while still maintaining the first position when mounted to a building. This allows the length of each side of the light wing to be varied depending upon where the light wing will be used.

The mounting mechanism 14 in this embodiment comprises a set of mounting brackets that mount to the ends of the pivot axis 16 but can comprise a similar mounting mechanism or any other mounting mechanism known to those skilled in the art. The mounting mechanism 14 allows the light wing 12 to rotate while mounted in the mounting mechanism 14 in response to force applied to the exterior of the light wing 12. In the illustrated embodiment, the mounting mechanism 14 is attached to the light wing 12 by attaching to the axis of rotation 16. When a force encounters either the top 20 of the light wing or the bottom 22 of the light wing, the light wing rotates away from the force, generally in the same direction as the magnitude of the force, thus allowing the light wing to rotate in reaction to the force, as opposed to breaking in reaction to the force. For example, the force can comprise a strong wind, a bird flying into the light wing, a falling object hitting the light wing, or even in some situations, a bird such as a goose attempting to nest or perch at the top of the light wing. Additionally, in another embodiment the light wing 12 can be adjusted such that the amount of force required to rotate the light wing is increased.

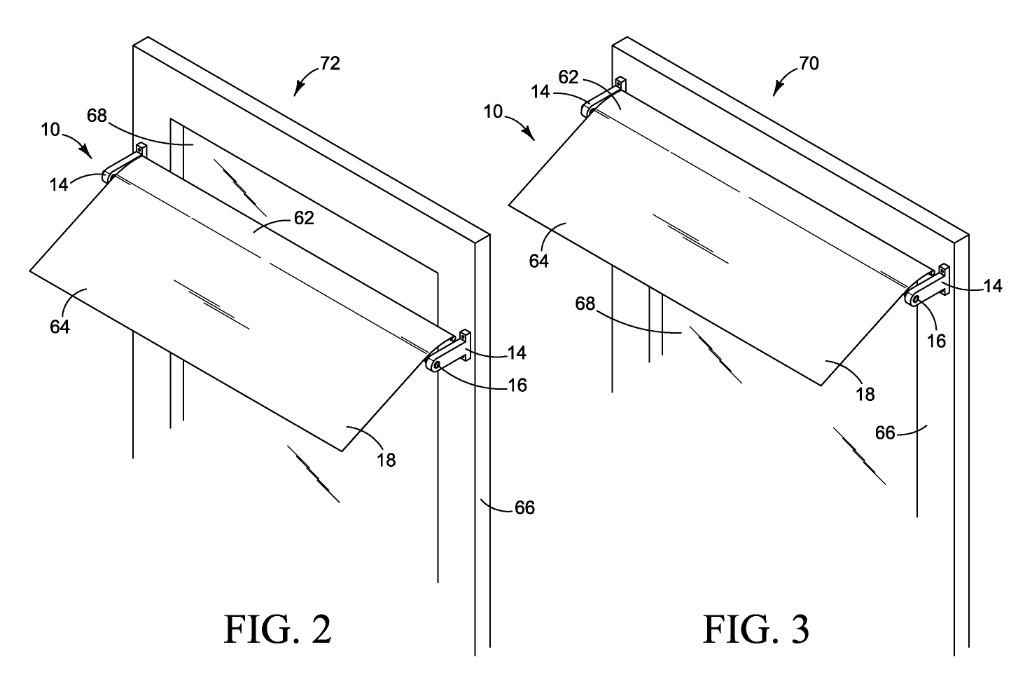

FIGS. 2 and 3 illustrate two different potential uses of the light wing device 10. Although the light wing device 10 can be positioned at a variety of heights, angles, or a combination of the two, in FIG. 2 the light wing device is located 72 below the top of the window 66 such that the light wing device 10 provides shade for the window by reflecting some of the light away from entering the window, while at the same time providing light to the area on the interior of the window by reflecting light onto the ceiling of the room. In periods when cooling of a room is desired, the light wing device can be configured to allow the room to be lit by outside light, thus saving lighting energy, while at the same time reflecting light away from the window thus preventing excess heat build up within the room. Alternatively, as illustrated in FIG. 3, the light wing device can be positioned at the top of a window 70 specifically to provide shade to the window to keep the interior of the building cool. Additionally, the orientation of the light wing can allow light that has a relatively low angle of travel direction in relation to the building to enter directly into the room. Accordingly, this allows the light wing device to provide light to the room while providing minimal amounts of heat to the room as the light is oriented at a generally low angle in relation to the building. For example, light generated when the sun is at a high angle, such as at three in the afternoon on a hot summer day, has a higher heating capacity than light of the evening sun. This is because the light rays of the afternoon travel through a smaller portion of the atmosphere than does the light of the evening sun which travels at a lower angle.

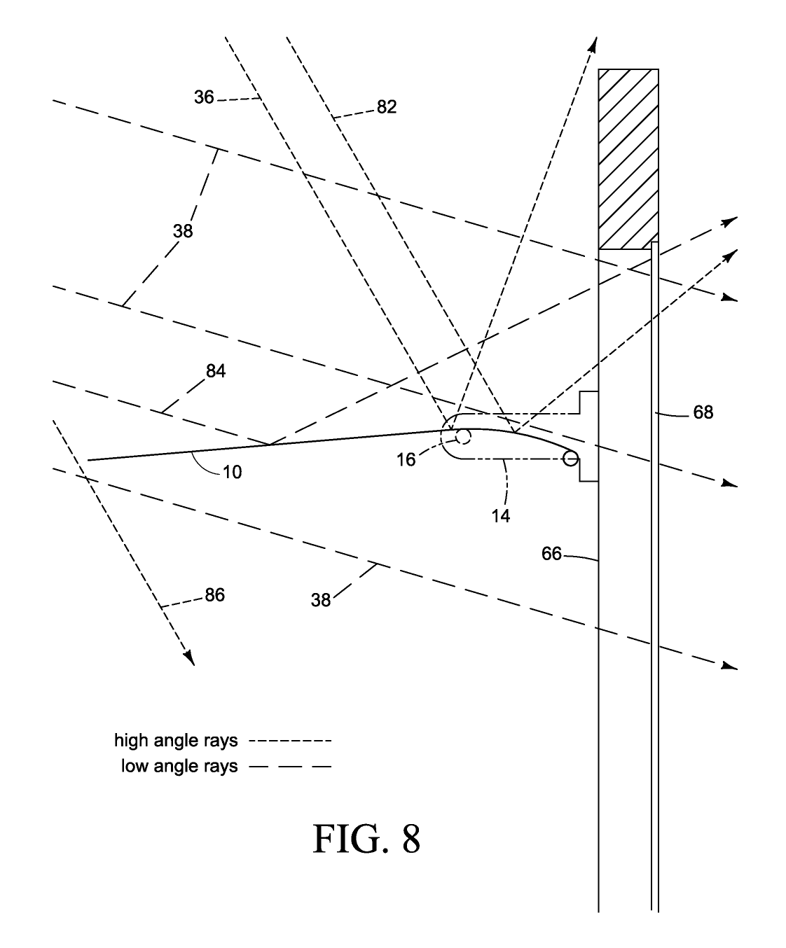

Alternatively, in more northern climates the light wing device can be configured to reflect both high angle light and low angle light into the building in order to provide heat and light during the winter months, thus cutting the cost of heating the interior of the building. FIG. 8 illustrates the general light reflecting and shade providing characteristics of the light wing device. In this embodiment, the initial position of the light wing can be adjusted to set the optimal position depending on the season as discussed above.

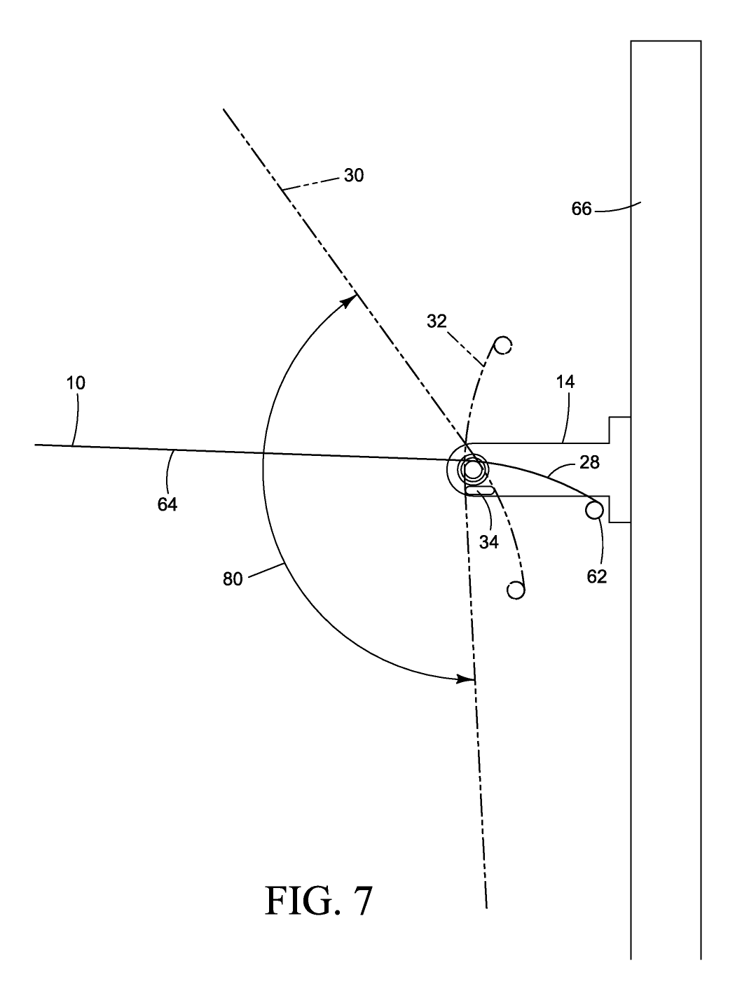

FIG. 7 illustrates an embodiment of the movement 80 of the light wing in reaction to a force as described above. In this embodiment the light wing 12 is oriented in a general first position 28 that the light wing is biased to maintain in the absence of any force being applied to the light wing. When a force is applied to the light wing 12, the light wing 12 moves toward an upward movement stop position (referred generally to as a second position) 30 or toward a downward movement stop position (referred generally to as a third position) 32. The relative range of movement of the light wing 12 in reaction to a force can vary widely and in the illustrated embodiment can be preset when the light wing is installed on a building or window. In this embodiment, the biasing element 26 allows the light wing 12 to move between the second position and the third position when a force is applied to the light wing 12, but biases the light wing 12 back toward the first position when the force is reduced. In this embodiment, the biasing mechanism has a stop point 34 that stops the light wing from moving beyond the stop point 34 in either rotational direction and subsequently the biasing mechanism biases the light wing 12 back toward the first position. Alternatively, the light wing device can include a stop point that can be positioned to restrict the relative movement of the light wing in response to a force. As illustrated, the mounting bracket 14 is transparently depicted in FIG. 7 to illustrate the movement of the light wing viewed through the mounting bracket 14.

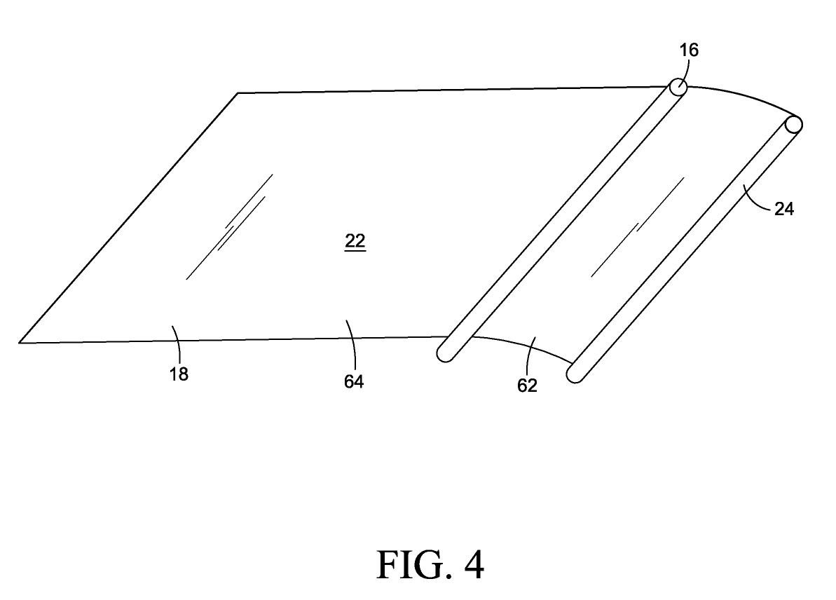

FIG. 4 illustrates an embodiment of the light wing 12 as a sheet 22 having a pivot axis 16 and a weight system 24 that allows the light wing to maintain the general first position 28 in reference to the mounting mechanism 14. The bottom 22 of the light wing 12 illustrates that in an embodiment of the invention the axis of rotation 16 can be a dowel or similar structure that runs the width of the light wing. Alternatively, the axis of rotation can be a crease in the light wing sheet, a cylindrical tube running beneath the sheet, or a wide variety of materials or structures that a person of ordinary skill in the art would use to design an axis of rotation. In the embodiment illustrated in FIG. 4, the axis of rotation can be positioned such that the first half of the sheet 64 is longer than the second half of the sheet 62, as the first half of the sheet is weighted as a counter balance to the increased weight of the second half of the sheet due to the increased length of the first half of the sheet. In this embodiment, the sheet 18 is balanced such that the second half of the sheet is generally the same as the first portion of the sheet 22 in order for the light wing to maintain the first position when the light wing is in a static environment. The light wing is balanced such that when the sheet rotates away from the first position towards a second position or a third position, the sheet is counter balanced to return toward the first position.

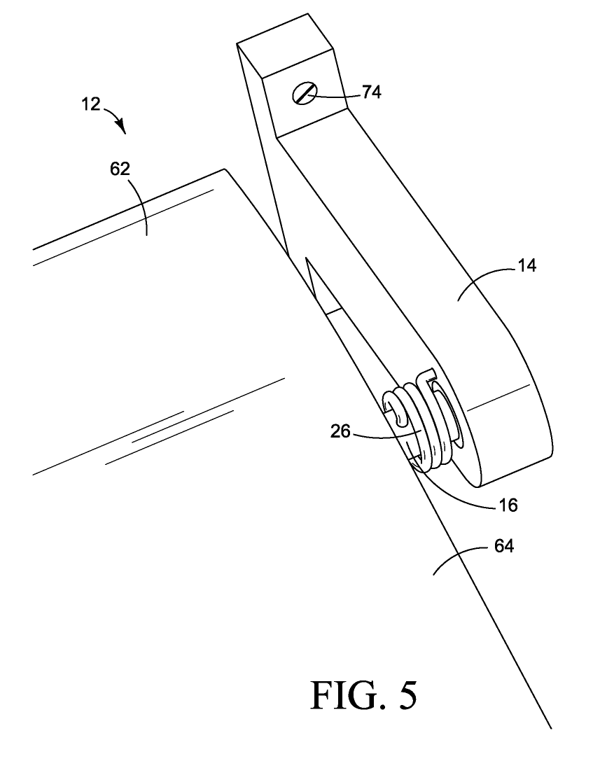

FIG. 5 illustrates a close view of an embodiment of the invention in which the light wing 12 is attached to the mounting mechanism 14 at the axis of rotation 16. A biasing mechanism 26, which in this embodiment is a spring mechanism, is positioned to bias the light wing 12 from a position away from the first position back toward the first position. Although the biasing mechanism in this embodiment comprises a spring system, the biasing mechanism can also be a weight system, a combination of the two, or any other system known to a person having ordinary skill in the art. Additionally, the biasing system can comprise a mechanized or motorized system that can either passively bias the light wing back to the first position or a user can actively bias the light wing back to the first position. As illustrated, in this embodiment the mounting mechanism is a mounting bracket that is attached to a window or wall of the building by a connecting system. Also as illustrated, the connection system for connecting the mounting brackets to the building or to a window frame of the building comprises a set of screws 74 that screw the mounting mechanism to the window frame or wall. Alternatively, the mounting brackets can be mounted to the building or window frame by a wide variety of connection systems including, but not limited to, an adhesive system, a series of plunger like objects, or any other connection system known to a person having ordinary skill in the art.

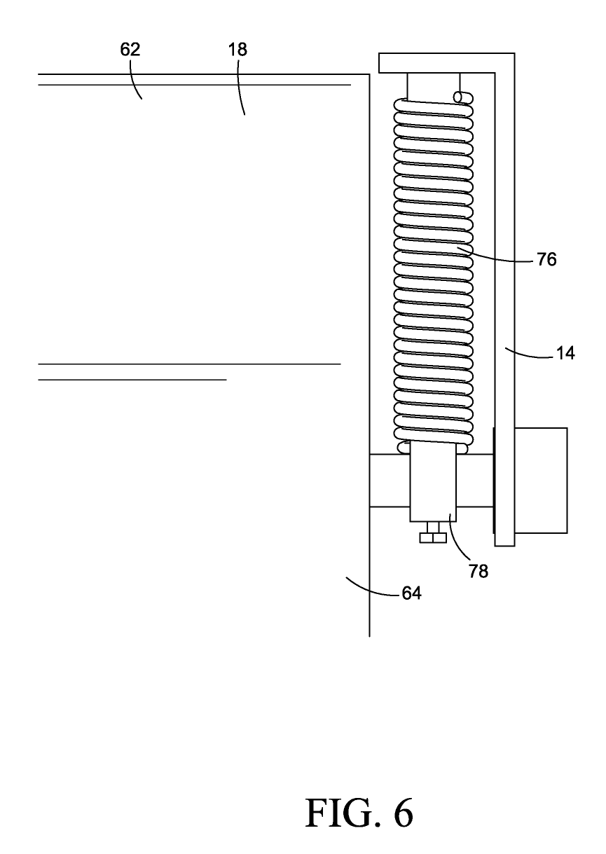

FIG. 6 illustrates an alternative embodiment of the biasing mechanism. In the depicted embodiment, the mounting mechanism is attached to the biasing device in an alternate format. As illustrated, the mounting mechanism is attached to the biasing mechanism 76 at the axis of rotation point 16 such that when the light wing rotates in reaction to a force, the return tensioner 76 biases the light wing back toward the first position. The return tensioner 76 can be adjusted by the adjustable attachment 78 of the return tensioner 76 in order to change the distance between the second point of travel of the light wing and the third point of travel, as well as the force the tensioner 76 places on the light wing 12 when biasing the light wing 12 back toward the first position.

FIG. 8 represents the shade providing capabilities and light reflecting capabilities of the light wing device. In the illustrated embodiment the light wing device 10 reflects light 36, 82, 84, 86. In the illustrated embodiment some light 82 is reflected into the building. Additionally, light is reflected off of the light wing 12 and away from the building 36. The light wing 12 is configured for some light to be allowed into the building via reflection whereas other light is reflected off and away from the window to prevent excess heat or light from entering into the building. Additionally, low angle light 38 is allowed to pass directly into the window. This allows for low energy level light to pass directly into the building. Again in this view, the mounting mechanism 14 is illustrated in a transparent view to illustrate the positioning of the light wing in reference to the mounting system and the window 68.

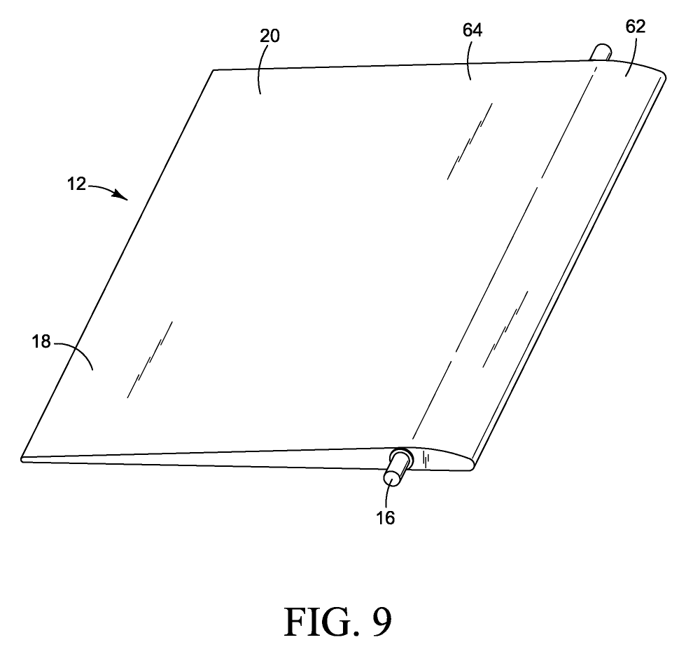

FIG. 9 illustrates another sheet embodiment of the light wing. The term “sheet” throughout this document is used to refer to any light wing that can be mounted in the mounting mechanism of the invention to reflect light and is responsive to force so as not to break. In this embodiment, the light wing is a one piece sheet that has an axis of rotation 16 around which the light wing 12 rotates. The sheet has varied thicknesses to generate an even weight distribution to maintain the sheet in the first position when mounted in the mounting mechanism 14. In this situation, the light wing itself is designed to have the weight system within the light wing. As illustrated, the light wing device 10 has a light wing 12 has a top 20 and two sections 64 and 62 that are divided by the pivot axis 16. The pivot axis 16 can be a dowel or similar feature that runs fully thought the light wing 12, two prongs extending from the light wing 12 that create a pivot axis of the light wing when the wing is mounted in the mounting mechanism, or any other pivot axis known to a person having ordinary skill in the art.

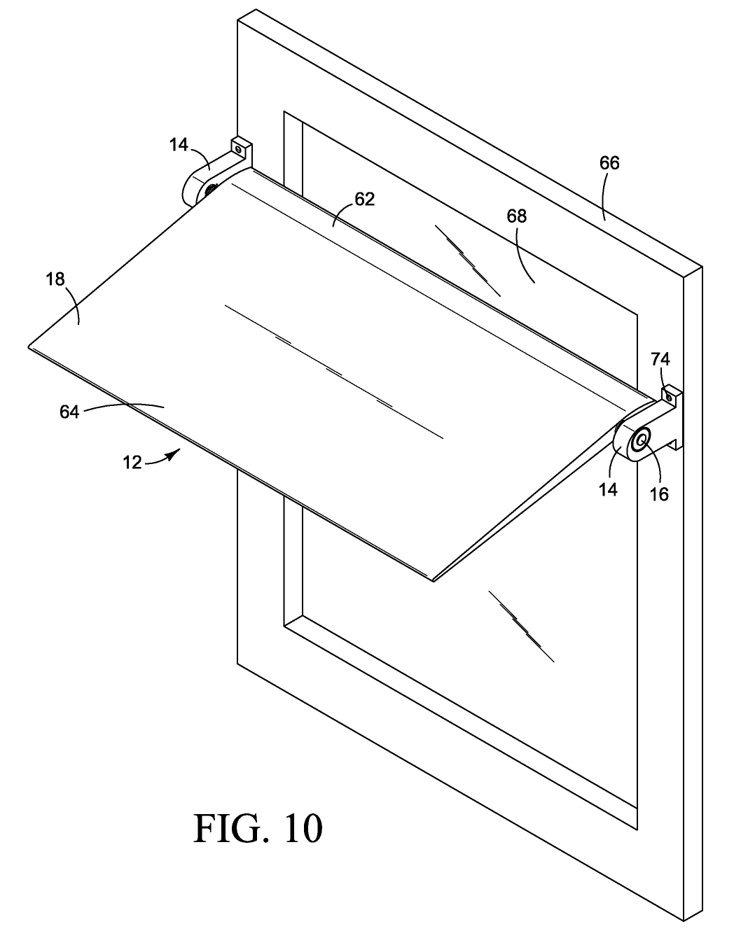

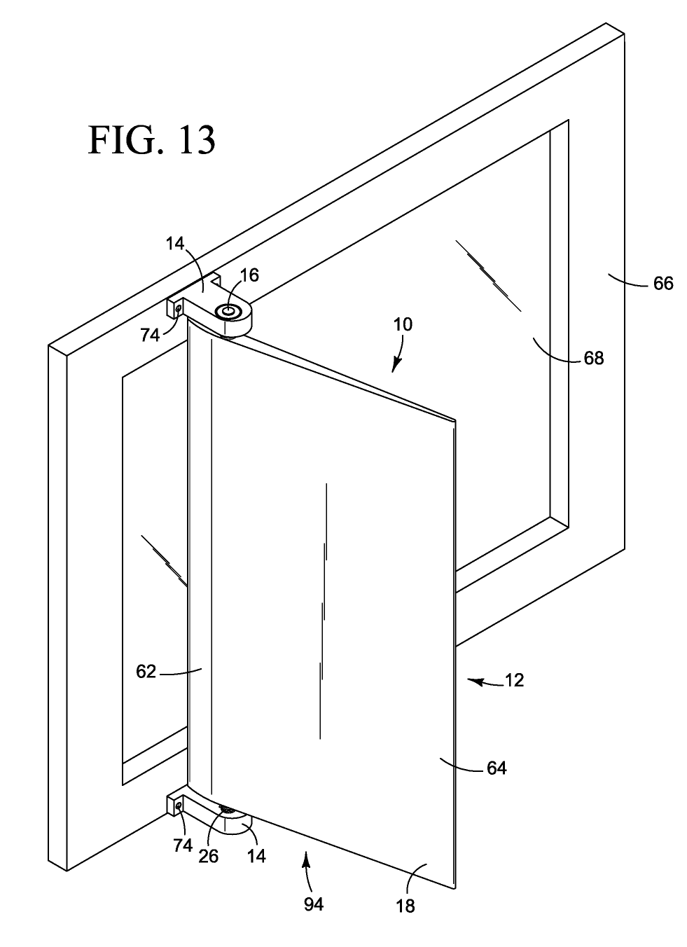

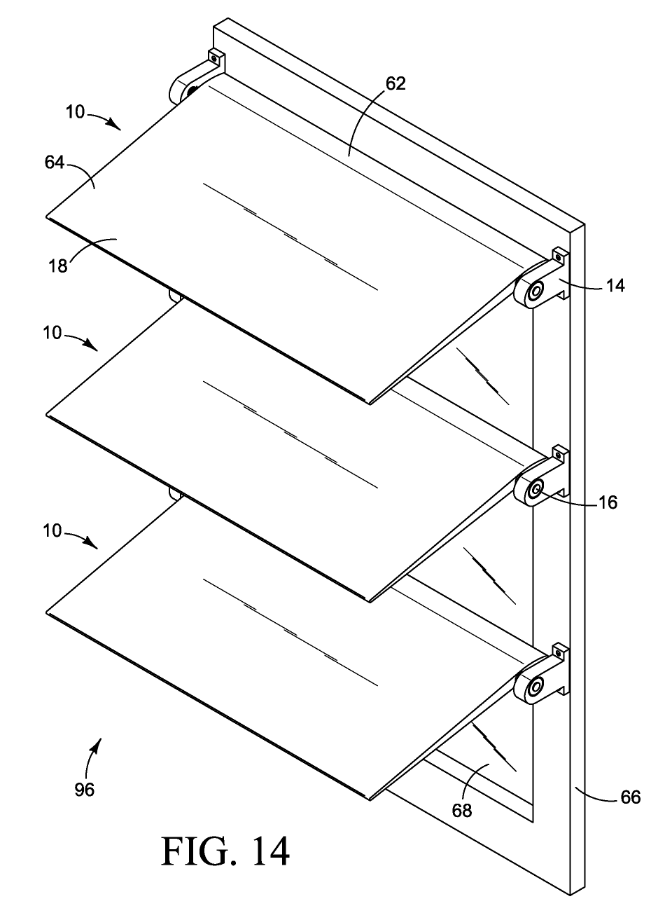

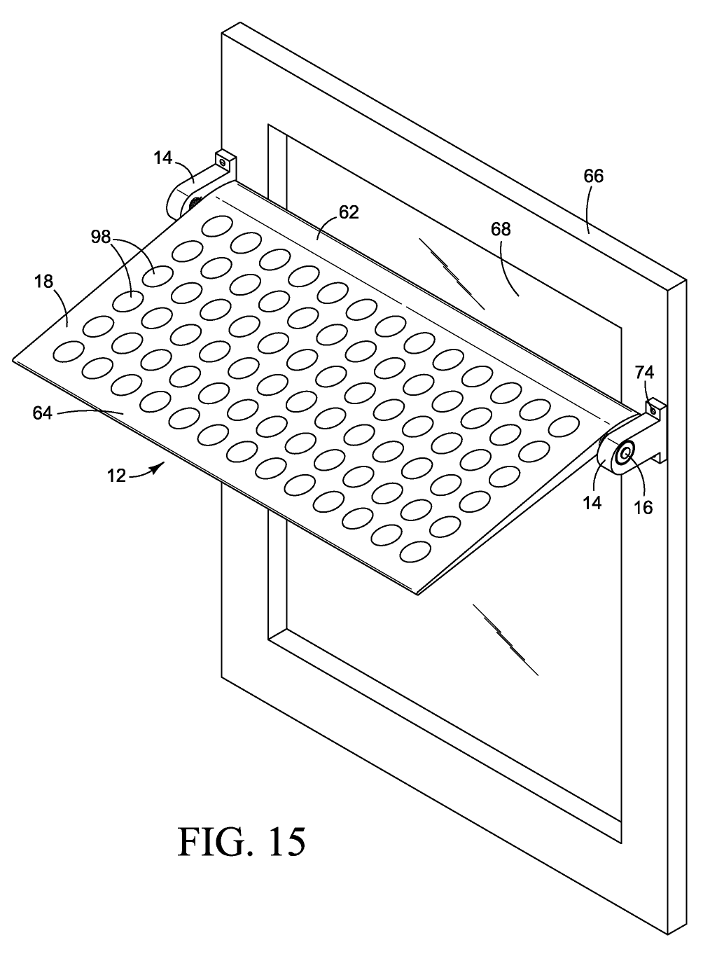

FIG. 10 illustrates the embodiment of the light wing of FIG. 9 mounted horizontally as the light wing device to a building in association with a window 68. In this embodiment, the mounting mechanism 14 is attached to the window frame 66 in association with the window 68. Alternatively, FIG. 13 illustrates the embodiment of the light wing of FIG. 9 mounted vertically 94 in combination with the other aspects of the light wing device. This mounting style is ideal on east facing and west facing positions where there is less high, direct sunlight on the window. This allows for more low light sources to be reflected both away from and into the window. FIG. 14 illustrates a plurality 96 of the embodiment of the light wing of FIG. 9 mounted horizontally in combination with the other aspects of the light wing device. Mounting a plurality of light wing devices in association with a window allows for increased light reflection and shade providing capabilities in the system. This is generally applicable when there is a large window and a plurality of light wing devices is needed to provide enough shade for the window. Additionally, this embodiment can be used if the window is in the sun for a long period of the day or subject to significant high intensity light and requires additional light reflection or shading properties. The light wings of the plurality of light wing devices can be connected with a connecting rod or a series of connecting rods such that the light wings move synchronously in reaction to a force impacting one of the light wings. This can prevent the light wings 12 from impacting one another and being damaged. Furthermore, the plurality of light wing devices can be interconnected such that when a user alters the initial relative position of one of the light wings each of the relative positions of the light wings changes. In this embodiment there would be considered a master light wing device and one or more slave light wing devices wherein the light wing of each of these devices changes in reaction to the light wing of the master light wing device changing. Alternatively, the light wing device system can be set such that the mechanism changes all of the light wings at once. The light wing devices can also be positioned diagonally in relation to a window or building or in any orientation relative to a window or building. Additionally a plurality of light wing devices can be mounted in a line to cover larger windows or buildings. The light wing devices can be made in any shape or size that will function for the intended purpose of the light wing device in providing light reflection while being reactive to force.

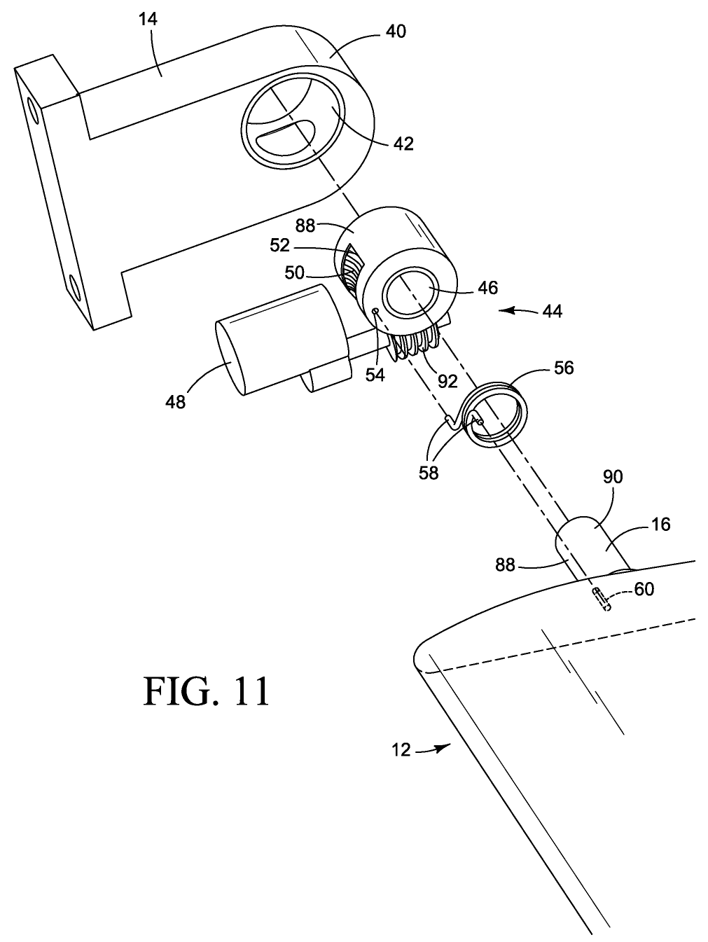

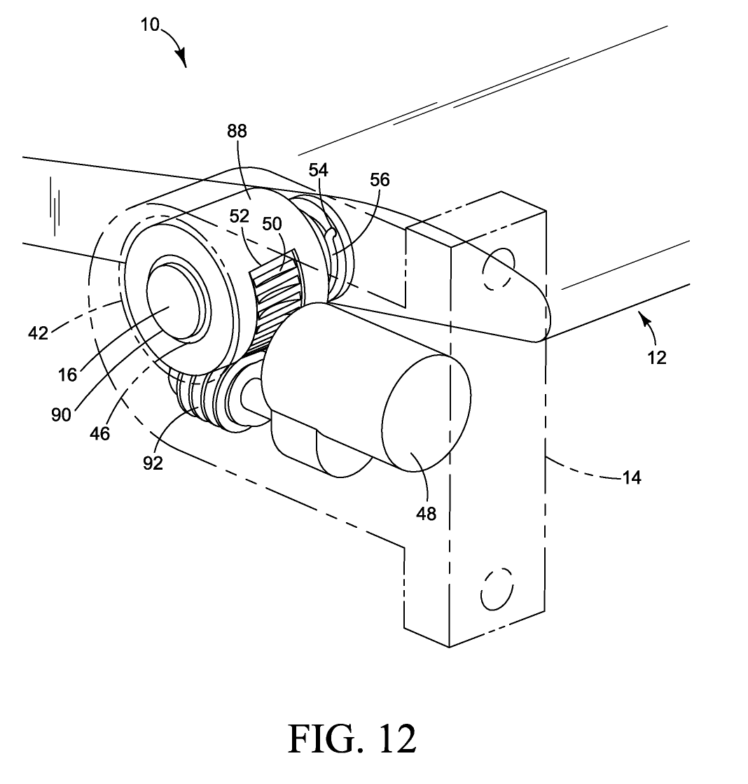

FIG. 11 represents an exploded view of one embodiment of the biasing mechanism as well as an embodiment of the mechanism for adjusting the relative orientation of the first position 28. Beginning at the mounting bracket 14, the mounting bracket comprises a pillow block 40 that has a gear bushing system 42 in which the axis of rotation 16 fits into generally at the end point of the axis of rotation. The biasing mechanism 56 in this embodiment comprises a spring, in the depicted embodiment a wrap-up coil spring 56, that has spring tangs 58 that fit into holes 60 on the mounting wing 12. The shaft bushing 46 of the pivot axis fits over the wing pivot shaft 90 such that the light wing 12 can pivot around the shaft 90 of the pivot axis 16 to rotate in reaction to a force impacting the light wing 12. The pivot axis has a bearing surface 88 that allows the ends of the pivot axis to rotate within the shaft bushing 46 of the worm gear set 44. In the illustrated embodiment, the mechanism for changing the relative first position of the light wing 12 comprises a motorized mechanism. Although in the illustrated embodiment the adjustment mechanism comprises a motorized mechanism, a wide variety of mechanisms can be used, including but not limited to, a mechanical system for altering the position by a user on the interior of the building, by rotation of a wheel or similar device to adjust the system. Additionally the mechanism can be similar to a ball bearing attached to the light wing 12 that fits into a recess on the mounting mechanism 14, or vice verse, that operates similarly to the mechanism by which a drill bit is held by a drill. In sum, any device that can alter the relative first position of the light wing in relation to the mounting mechanism 14 or a building or window can be used. Furthermore, a breakaway device can be used to allow the light wing to react to a force impacting the light wing 12. The breakaway device can be configured such that instead of rotating on the pivot axis, the light wing can break away at the pivot axis as opposed to rotate on the pivot axis. The light wing device can be configured to either automatically return to the first position or to be manually operated to return to the first position after reacting to the force via the breakaway device. In the depicted embodiment, upon a person engaging the motor or an automated system engaging the motor, the motor 48 engages the gear ring 50 of the adjustment system that has a gear rotation stop 52 such that the location of the first position in relation to the mounting brackets 14 changes. This occurs when the gear motor 48 engages the worm gear screw 92 which in turn causes rotation of the gear ring 50, which is part of the worm gear set 44, which in turn rotates location of the first position of the light wing 12. Subsequently FIG. 12 illustrates an unexploded view of an embodiment of the biasing mechanism and an embodiment of the mechanism for changing the location of the first position of the light wing in relation to the mounting mechanism.

FIG. 14 depicts the light wing device 10 in which the light wing 12 has a solar energy converter 98 mounted on the light wing 12. In this embodiment the light wing device 10 can provide shade and light reflection while harnessing the energy of the light.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. A light wing device for reflecting light for a window of a building, wherein said light wing device comprises:
a light wing configured for reflecting light, wherein said light wing comprises a pivot axis configured such that said light wing is configured to rotate on said pivot axis, wherein said light wing comprises a first side and a second side, wherein said pivot axis is positioned and configured such that said light wing is configured to rotate on said pivot axis in a first direction toward said first side of said light wing and configured to rotate in a generally opposite second direction to said first direction toward said second side of said light wing;
a mounting mechanism configured for attachment to said light wing and configured for mounting said light wing in association with said window, wherein said mounting mechanism is configured such that said light wing is configured to rotate on said pivot axis when mounted with said mounting mechanism in association with said window; and
wherein said light wing is configured to be mounted in association with said window in a general first position, wherein in said first position said light wing is configured to provide light reflection, wherein said light wing is configured such that when a force is applied generally to said first side of said light wing or said second side of said light wing when said light wing is in said first position said light wing rotates generally away from said force to prevent said light wing from breaking from said application of force, wherein said light wing is configured to be biased to rotate back toward said first position when said force is reduced.

2. The light wing device of claim 1 wherein said light wing device is mounted on a building with said light wing being in said first position in which said light wing is generally configured to provide shade from light and to provide indirect lighting to said window by reflecting at least a portion of said light into said window.

3. The light wing device of claim 1 wherein said light wing comprises a biasing mechanism for biasing said light wing from a position toward said second position or a position toward said third position back toward said first position when said application of force is reduced.

4. The light wing device of claim 3 wherein said biasing mechanism comprises at least one biasing spring positioned and configured to provide at least a first and a second stop point for said rotation of said light wing, wherein said first stop point of light wing rotation is generally located toward said second position, wherein said first stop point is configured to prevent said light wing from rotating past said first stop point, wherein said second stop point is generally located toward said third position, wherein said second stop point is configured to prevent said light wing from rotating past said third position, wherein said biasing spring allows said light wing to rotate generally toward said second position or generally toward said third position when a force is applied to said light wing, wherein said biasing spring biases said light wing back toward said first position when said force is reduced.

5. The light wing device of claim 4 wherein said light wing is attached to said mounting mechanism generally at said pivot axis, wherein said at least one of said biasing springs is attached to said pivot axis and attached to said mounting mechanism such that said biasing spring controls said rotation of said light wing relative to said mounting mechanism.

6. The light wing device of claim 3 wherein said light wing comprises a first section and a second section, wherein said first section and said second section are separated by said pivot axis, wherein said biasing mechanism comprises a weight system configured such that said first section and said second section are weighted such that said light wing is configured to return generally back to said first position when moved toward said second position or said third position.

7. The light wing device of claim 1 wherein said light wing device comprises an adjustment mechanism configured for varying said first position of said light wing.

8. The light wing device of claim 7 wherein said adjustment mechanism comprises at least one of a mechanically driven mechanism or a motor driven mechanism.

9. The light wing device of claim 7 wherein said adjustment mechanism comprises a mechanism operated by a person or an automated adjustment mechanism.

10. The light wing device of claim 9 wherein said automated adjustment mechanism is configured to respond to environmental factors.

11. The light wing device of claim 1 wherein a plurality of light wing devices are mounted on a window to provide light reflection.

12. The light wing device of claim 1 wherein at least one light wing device is mounted vertically on a window to provide light reflection.

13. The light wing device of claim 1 wherein said light wing comprises at least one solar energy converter positioned on said light wing to collect solar energy.

14. The light wing device of claim 1 wherein said light wing comprises a sheet having a first section and a second section, wherein said first section and said second section are separated by said axis of rotation, wherein said first section comprises a light reflecting section having a mass, wherein said second section comprises a mass, wherein said mass of said first section and said mass of said second section are configured such that said light wing is counter balanced such that when said light wing swings away from said first position in reaction to said force said light wing is biased to swing back toward said first position.

15. A light wing device for reflecting light for a window of a building, wherein said light wing device comprises:
a light wing configured for reflecting light, wherein said light wing comprises a pivot axis positioned such that said light wing is configured to rotate on said pivot axis, wherein said light wing comprises a first side and a second side, wherein said pivot axis is positioned and configured such that said light wing is configured to rotate on said pivot axis in a first direction toward said first side of said light wing and configured to rotate in a generally opposite second direction to said first direction toward said second side of said light wing;
a mounting mechanism configured for attachment to said light wing and configured for mounting said light wing in association with said window, wherein said mounting mechanism is configured such that said light wing is configured to rotate on said pivot axis when mounted with said mounting mechanism in association with said window, wherein said light wing is configured to be mounted in association with said window in a general first position, wherein in said first position said light wing is configured to provide light reflection, wherein said light wing is configured such that when a force is applied generally to said first side of said light wing or said second side of said light wing when said light wing is in said first position said light wing rotates generally away from said force to prevent said light wing from breaking from said application of force, wherein said light wing is configured to be biased to rotate back toward said first position when said force is reduced; and
an adjustment mechanism configured for varying said first position of said light wing.

16. The light wing device of claim 15 wherein said light wing comprises a biasing mechanism for biasing said light wing from a position toward said second position or a position toward said third position back toward said first position when said application of force is reduced.

17. The light wing device of claim 16 wherein said biasing mechanism comprises at least one biasing spring positioned and configured to provide at least a first and a second stop point for said rotation of said light wing, wherein said first stop point of light wing rotation is generally located toward said second position, wherein said first stop point is configured to prevent said light wing from rotating past said first stop point, wherein said second stop point is generally located toward said third position, wherein said second stop point is configured to prevent said light wing from rotating past said third position, wherein said biasing spring allows said light wing to rotate generally toward said second position or generally toward said third position when a force is applied to said light wing, wherein said biasing spring biases said light wing back toward said first position when said force is reduced.

18. The light wing device of claim 17 wherein said light wing is attached to said mounting mechanism generally at said pivot axis, wherein said at least one of said biasing springs is attached to said pivot axis and attached to said mounting mechanism such that said biasing spring controls said rotation of said light wing relative to said mounting mechanism.

19. The light wing device of claim 1 wherein said light wing comprises at least one solar energy converter positioned on said light wing to collect solar energy.

20. A light wing device for reflecting light for a window of a building, wherein said light wing device comprises:
a light wing configured for reflecting light, wherein said light wing comprises a pivot axis positioned such that said light wing is configured to rotate on said pivot axis, wherein said light wing comprises a first side and a second side, wherein said pivot axis is positioned and configured such that said light wing is configured to rotate on said pivot axis in a first direction toward said first side of said light wing and configured to rotate in a generally opposite second direction to said first direction toward said second side of said light wing;
a mounting mechanism configured for attachment to said light wing and configured for mounting said light wing in association with said window, wherein said mounting mechanism is configured such that said light wing is configured to rotate on said pivot axis when mounted with said mounting mechanism in association with said window, wherein said light wing is configured to be mounted in association with said window in a general first position, wherein in said first position said light wing is configured to light reflection, wherein said light wing is configured such that when a force is applied generally to said first side of said light wing or said second side of said light wing when said light wing is in said first position said light wing rotates generally away from said force to prevent said light wing from breaking from said application of force, wherein said light wing is configured to be biased to rotate back toward said first position when said force is reduced;
an adjustment mechanism configured for varying said first position of said light wing; and
a biasing mechanism for biasing said light wing from a position toward said second position or a position toward said third position back toward said first position when said application of force is reduced.
